(19) United States
(12) Patent Application Publication
(10) Pub. No.: US 2019/0360472 A1
(43) Pub. Date: Nov. 28, 2019

(54) ENERGY GENERATING STATION

(71) Applicant: Bardot Group, La Ciotat (FR)

(72) Inventors: Maëva ALETAS, Marseille (FR); Pierre GUERIN, Toulon (FR); Frédéric CEFFIS, Aubagne (FR)

(73) Assignee: Bardot Group, La Ciotat (FR)

(21) Appl. No.: 16/469,874

(22) PCT Filed: Dec. 16, 2016
(86) PCT No.: PCT/FR2016/053531

§ 371 Date: Jun. 14, 2019

(51) Int. Cl. F03G 7/05; H02K 7/18

(52) U.S. Cl. CPC F03G 7/05; H02K 7/1823

(57) ABSTRACT

The invention relates to an energy generating station comprising an electrical energy generating system and a warm water and cold water production system cooperating with the electrical energy generating system. Optionally, the energy generating station also comprises a desalination module and a climate-based energy generating system, both cooperating with the electrical energy generating system.

The invention relates to the field of energy generating devices and systems, particularly those using technologies based on Ocean Thermal Energy or OTE, also known as Ocean Thermal Energy Conversion (OTEC). Such technologies have many uses, and preferably, without limitation, to supply energy on isolated sites such as for example an archipelago, preferably but not limited to a tropical zone, for example a hotel complex in the Maldives.

Currently, oil, natural mineral oil and mixture of hydrocarbons are exploited abundantly, being at the center of life of everyone and consequently at the center of the world economy. It is for good reason, therefore, that this fossil fuel is called “black gold.” Indeed, oil:
supplies most of the liquid fuels, such as, by way of non-limiting examples, LPG, fuel oil, diesel fuel, kerosene, gasoline;
is the basis for many objects in common life, such as by way of non-limiting examples, textiles, cosmetics, fertilizers, detergents, etc., in the form of naphtha when it is produced by refining, then transformed by petrochemistry;
is also used in the composition, among other things, of asphalts, lubricants and paraffins.

Moreover, oil has many advantages, because being a source of liquid energy, it is easy to pump, store, transport and use. Furthermore, it offers a high density of energy. Nevertheless, like any fuel or fossil fuel, oil is a non-renewable energy source, since it requires millions of years to be formed and the resources of oil are being exhausted more quickly than they are being produced. Finally, oil and other fossil fuels are not considered to be green energy sources, since their use has a direct or indirect impact on the environment. Indeed, on locations for example in direct proximity to a hotel center, generators can be employed to produce electricity autonomously. These generators, however, prove to be cumbersome to set up, since they involve being supplied with fuel or fossil fuel, which is costly and not clean. As a variant or in compliment, other devices and/or systems for producing electric energy are deployed by exploiting solar energy. Although less polluting, such devices and/or systems have a number of disadvantages, since their good operation is relative to sunshine.

To remedy such disadvantages, man has had to seek solutions from resources that are nearly inexhaustible and present on our planet. Because of their extent over the earth, oceans and seas act as an immense collector of solar radiation, enabling the heating of upper layers of said oceans and seas. These upper layers, called “warm,” do not mix with the lower layers called “cold” that are present at depth. Indeed, the density of water increases when the temperature thereof decreases. Based on this difference in temperatures, systems for generating energy, such as for example electricity, have subsequently been developed using technologies based on OTE or OTEC. However, such thermal systems for production of electric energy, also known as “OTE power plants,” are generally only usable in inter-tropical zones, in order to obtain sufficient production performance. Indeed, such performance depends on the temperature difference between the sources of warm water and cold water. For optimal operation, that difference must be on the order of 20° C. In addition to the production of electric energy, such systems can potentially enable the generation of other “energy,” useful for example for the ambient cooling of a room or to irrigate cultivated lands.

Conceptually, OTE systems produce energy by the presence of a working fluid, such as for example ammonia, seawater or any other fluid for which the condensation point corresponds to a temperature close to 4° C. Such an OTE system generally comprises an evaporator in which said working fluid is vaporized, in contact with warm water previously tapped at the surface. Once vaporized, that working fluid is sent to a turbine to drive the turbine in rotation and finally produce electricity. Then, in order to be condensed again, the working fluid is sent to a condenser included in the system, in contact with cold water this time, previously tapped at depth. Although generally comprising the same elements, systems employing OTE technologies can operate according to different cycles or embodiments.

According to a first embodiment, an OTE system can operate in open cycle: the warm seawater is advantageously and directly used to produce electricity. Indeed, said warm water is first pumped into a tank at low pressure or under vacuum. Said tank thus makes it possible to vaporize said warm water. The water vapor is thus pure. It is then sent to a turbine that it drives in rotation, said turbine being connected to an electric generator. The vapor is then introduced into a condenser while being exposed to cold seawater from the depths, in order to regain its liquid state. Said water, produced in final liquid form, can advantageously be used as potable water, for irrigation or for aquaculture. However, electric energy generating systems employing an open cycle of operation have disadvantages. First, because the cycle is open, it is often quite difficult to achieve a complete vacuum in the system, which generally reduces the operating performance of an open cycle. Also, the low pressure within the system requires the use of a turbine of large dimensions, resulting in costs and methods of manufacture, installation and maintenance that are expensive and complex.

According to a second embodiment, an OTE system can operate in closed cycle, usually modeled by an “Organic Rankine Cycle”—ORC. In this scenario, such an OTE electric energy generating system first comprises an evaporator in which warm water circulates that has been previously pumped at the surface. The warm water thus makes it possible to vaporize a working fluid advantageously having a low boiling point. Such is the case, for example, of ammonia. Said OTE system then comprises a turbine through which the vaporized working fluid passes. Said turbine is therefore driven by the vaporized working fluid, and the turbine in turn drives an electricity generator connected thereto. The working fluid in gaseous form is expanded in the turbine. The pressure of said fluid is therefore lower when exiting the turbine. The OTE system then includes a condenser enabling the condensation of said working fluid, said condenser circulating cold sea water in it to enable the condensation. The working fluid in liquid form is then sent by a circulation system, such as a pump, to supply the evaporator again and thus repeat the cycle.

According to a third embodiment, an OTE system can operate in a hybrid cycle. Such a hybrid cycle combines the characteristics of the open and closed cycle systems. In this configuration, an OTE electric energy generating system comprises a vacuum enclosure inside which saltwater is introduced and vaporized very quickly, like the evaporation method in the open cycle. The water vapor in turn vaporizes a working fluid, such as ammonia, present in a closed cycle circuit, positioned opposite the vaporizer of the working fluid. Said fluid thus vaporized drives a turbine, which in turn drives an electricity generator. Although making it possible to benefit from electric energy generating cycles, respectively open and closed, as previously described, said hybrid cycle has other disadvantages, particularly costs of investment, installation and maintenance, since twice the materials are necessary to implement a hybrid cycle. Moreover, due to a large discharge of cold water at the surface, the use of the hybrid cycle results in a greater cooling phenomenon of the surface waters that can be harmful for flora and fauna.

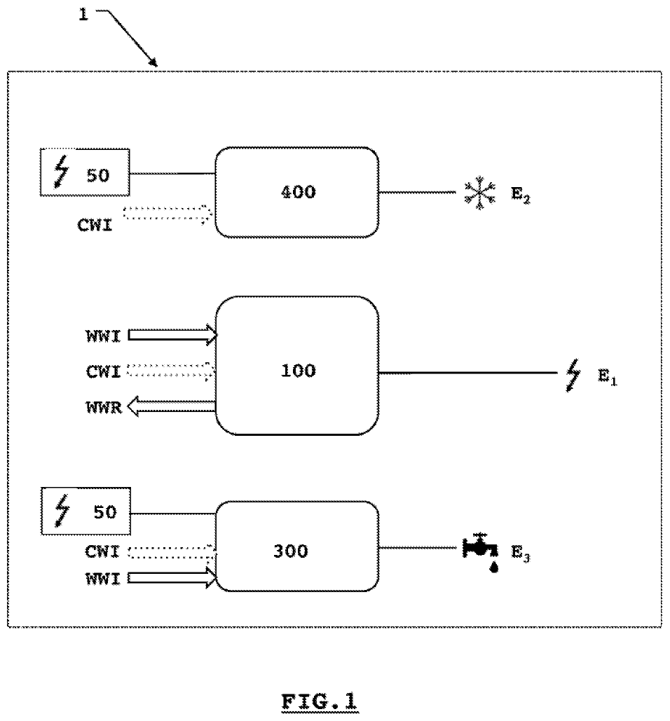

Furthermore, as previously mentioned, systems based on OTE or OTEC technologies are generally operated in intertropical zones, since in order to obtain satisfactory performance, it is necessary to have a sufficient thermal gradient between the cold and warm source(s) on the order of at least 20° C. Such intertropical zones include, depending on the case, isolated places where needs for resources or energy require importing and/or supplying said energy resources on site. Some systems developed for electric energy generation and based on OTE technologies have undergone improvements and/or perfections to meet the needs of sites on which they are installed. For example, when an electric energy generating system uses an open cycle, as described previously, such electric energy generating system can potentially enable the generation of freshwater or be coupled to one or more systems for generating air conditioning energy (also known as “seawater air conditioning systems—SWAC systems”). FIG. 1 shows a schematic example, simplified and non-limiting, of a system 1 enabling the production of different energy. Thus, according to FIG. 1, said system 1 comprises:
an OTE power plant or electric energy E₁ generating system 100, supplied with cold water CW and warm water WW respectively by cold water intake CWI and warm water intake WWI drawing seawater at depth and seawater at the surface;
an air conditioning energy E₂ generating system 400 supplied with cold water CW by a cold water intake CWI drawing cold seawater, generally but without limitation at depth, and with electricity by an electricity generator 50;
a desalination module 300 for generating freshwater E₃, supplied with cold water CW by a cold water intake CWI drawing cold seawater, generally but without limitation at depth, or supplied with warm water WW by a warm water intake WWI drawing warm seawater, generally but without limitation from the surface, and with electricity by an electricity generator 50.
   The different elements 100, 300 and 400 comprising a system 1 enabling the production of different energy are consequently juxtaposed and do not contribute to the operations of one another.

Thus, none of the current solutions offer “all-in-one” systems making it possible to respond to all the needs that such isolated sites may require, whether in terms of air conditioning, potable water, water for irrigation and/or domestic needs for running water. Consequently, such sites resort to a plurality of different autonomous generating systems, multiplying the costs of acquisition, installation and maintenance.

The invention makes it possible to respond to all or part of the disadvantages of known solutions.

Among the numerous advantages offered by an energy generating station according to the invention, we can mention that it makes it possible:
to limit or even eliminate the use of polluting fossil fuels and thus propose a system based on natural resources that are clean and renewable, producing little or no carbon dioxide or other polluting products;
to offer a continuous generating system, said generation being independent of sunshine;
to propose an integrated all-in-one system, suitable in particular to be implemented on isolated sites, such as for example an atoll, meeting all or part of the needs for resources and energy of the inhabitants of said atoll, thanks to the interaction and/or synergy of different technologies;
to reduce the number of pieces of equipment and devices used while facilitating the installation by a combination of elements within the station and by pooling the resources used for operation of the station.

To that end, an energy generating station is provided, comprising an electric energy generating system comprising:
a first warm water supply circuit comprising a first pump and a first warm water intake cooperating with said first pump;
a second cold water supply circuit comprising a second pump and a second cold water intake cooperating with said second pump;
a working fluid supply circuit comprising a circulation pump of said working fluid;
a first thermal exchanger cooperating fluidly with said first warm water supply circuit and said working fluid supply circuit;
a second thermal exchanger cooperating fluidly with said second cold water supply circuit and said working fluid supply circuit;
a turbine cooperating fluidly with the first and second thermal exchangers;
an electricity generator cooperating with said turbine by mechanical linkage;
a water output cooperating fluidly with the first and second thermal exchangers.

In order to offer an integrated “all-in-one” system potentially meeting the needs for resources and energy on isolated sites, while simplifying the setup and maintenance of an energy generating system according to the invention, said invention further comprises a warm water and cold water generating system cooperating fluidly with the water outlet of said electric energy generating system and comprising:
a third water supply circuit comprising a third pump cooperating fluidly upstream with the water outlet of the electric energy generating system;
a fourth water supply circuit comprising a fourth pump cooperating fluidly upstream with the water outlet of said electric energy generating system;
a refrigerating fluid supply circuit cooperating with a pressure reducer of said refrigerating fluid;
a third thermal exchanger cooperating fluidly with said third water supply circuit and said refrigerating fluid supply circuit;
a fourth thermal exchanger cooperating fluidly with said fourth water supply circuit and said refrigerating fluid supply circuit;
a compressor cooperating fluidly with the third and fourth thermal exchangers;
a fresh warm water outlet cooperating fluidly with said third thermal exchanger;
a fresh cold water outlet cooperating fluidly with said fourth thermal exchanger.
   Furthermore, the compressor of the warm water and cold water generating station of an energy generating station according to the invention is powered by the generator of the electric energy generating system.

According to a first advantageous but not limiting embodiment of an energy generating station according to the invention, the compressor of the warm water and cold water generating system of said invention can be powered by the electric energy delivered by said generator of the electric energy generating system.

As a variant, according to a second non-limiting embodiment of an energy generating station according to the invention, the turbine and the electricity generator of the electric energy generating system thereof can cooperate mechanically by means of a mechanical shaft, said shaft also cooperating mechanically with the compressor of the warm water and cold water generating system in order to drive said compressor.

As a variant or in addition, in order to offer other services in response to the needs on an isolated site, particularly for potentially consumable freshwater, an energy generating station according to the invention can further comprise a desalination module comprising a pump and a reverse osmosis membrane supplied with water by said pump, a freshwater outlet cooperating fluidly with said reverse osmosis membrane, said desalination module cooperating fluidly, upstream from said desalination module, with the water outlet of the electric energy generating system, and downstream from said desalination module, with the third and fourth water supply circuits of the warm water and cold water generating system.

Finally, as a variant or in addition, an energy generating station according to the invention can also and advantageously comprise an air conditioning energy generating system cooperating fluidly with the water outlet of the electric energy generating system, the air conditioning energy generating system comprising:
a fifth water supply circuit comprising a fifth pump and cooperating fluidly with the water outlet;
a heat transfer fluid supply circuit comprising a circulation pump of said heat transfer fluid;
a fifth thermal exchanger cooperating fluidly with said fifth water supply circuit and said heat transfer fluid supply circuit;
a sixth thermal exchanger cooperating fluidly with said heat transfer fluid supply circuit.

Other characteristics and advantages will be seen more clearly from the following description and by examining the figures accompanying it, in which:

FIG. 1 describes a simplified schematic view of a system enabling the generation of different energy according to the prior art;

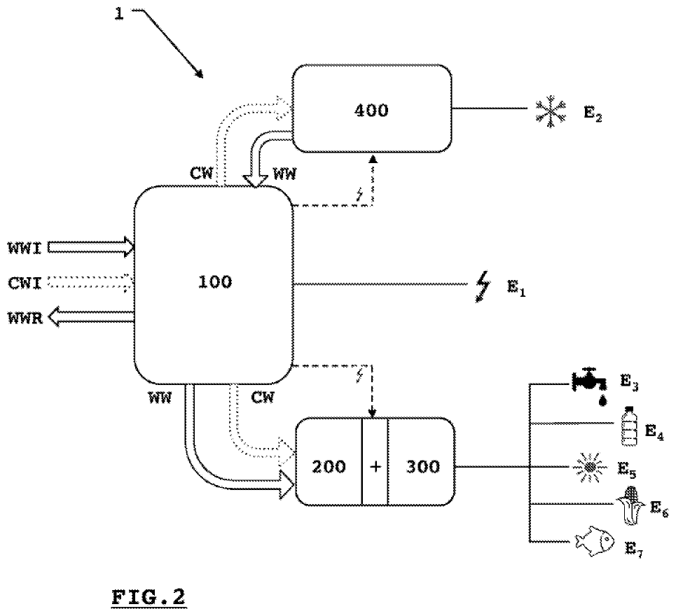

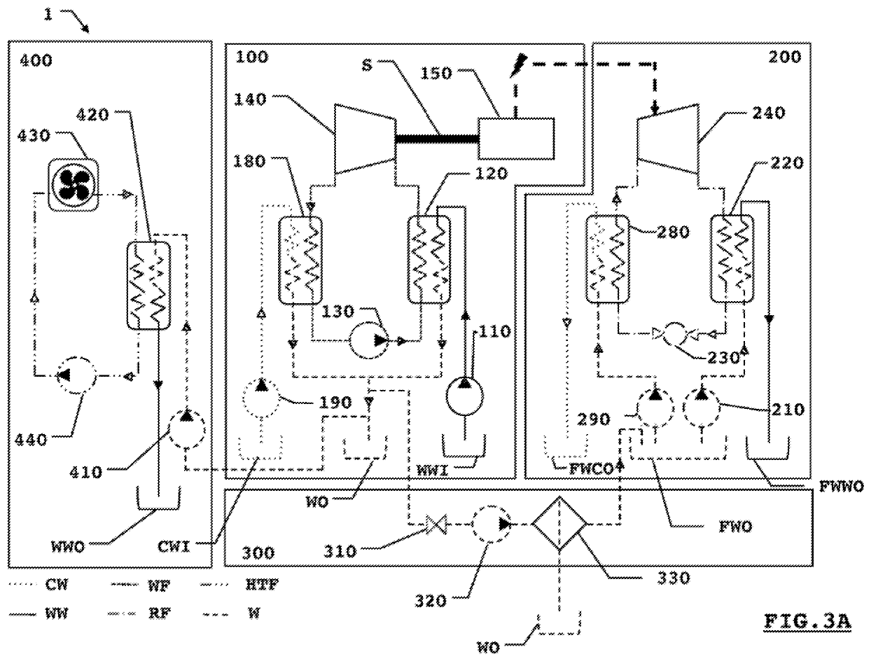

FIG. 2 illustrates a simplified schematic view of an energy generating station according to the invention;

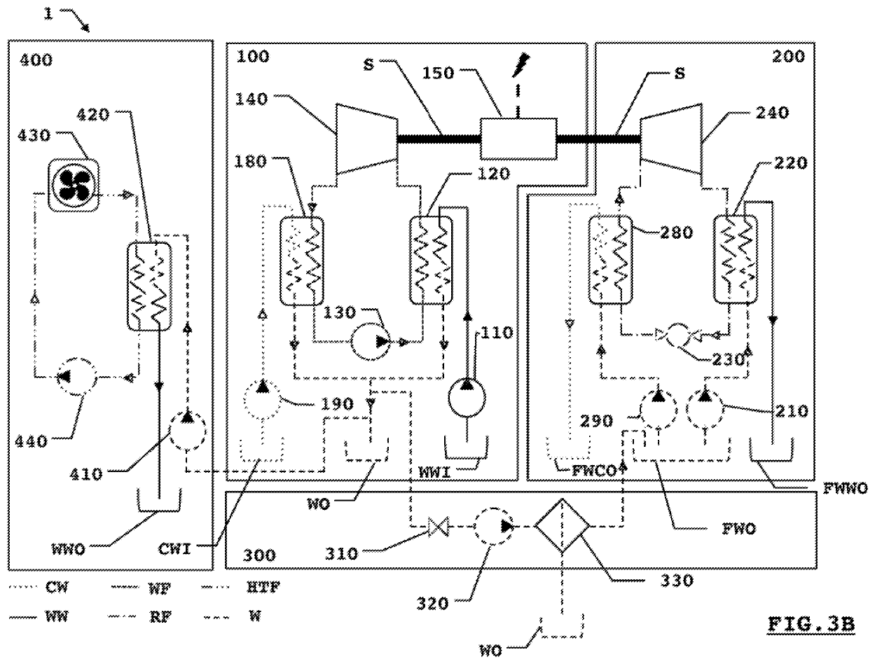

FIGS. 3A and 3B describe respective schematic views of a first and second embodiment of an energy generating station according to the invention.

FIG. 2 diagrams in a simplified way an energy generating station according to the invention. Throughout the document and in the sense used in the invention, “energy” is understood as being any resource, i.e. a material means, consumable and possibly produced by man. Thus, by way of non-limiting examples, according to FIG. 2 such energy (represented in FIG. 2 by icons) can advantageously consist of electricity E₁, conditioned air E₂, freshwater E₃, potable water E₄, warm water E₅, water suitable for use in agriculture or aquaculture E₆. The invention would not be limited to the type of energy generated by said station. However, preferably such energy will consist of electricity E₁, conditioned air E₂, cold water E₃ and warm water E₅. Also, an energy generating station according to the invention can be adapted to the functions and energy to be generated. Said station can thus comprise a plurality of systems enabling the generation of different energy. The term “powerplant” can be used interchangeably with “station.” By way of non-limiting examples, according to FIG. 2, an energy generating station 1 according to the invention comprises an electric energy generating system 100, supplied with warm water and cold water respectively by a warm water intake WWI and a cold water intake CWI and based on OTE technologies, a warm water and cold water generating system 300, supplied with cold water CW and electricity by said electric energy generating system 100 and an air conditioning energy generating system 400 supplied with cold water CW and electricity by said electric energy generating system 100 and also producing warm water WW for the electric energy generating system 100. The different systems mentioned above and the various inter-cooperation thereof will be described hereinafter, with reference in particular to FIGS. 3A and 3B. Potentially, still with reference to FIG. 2, an energy generating station 1 can also comprise a desalination module 300, supplied with water W, possibly cold water CW or warm water WW, by the electric energy generating system 100, and supplying water to the warm water and cold water generating system 300. Such a desalination module 300 in particular makes it possible to obtain freshwater, even in some cases water that is potable and/or consumable for common needs.

FIGS. 3A and 3B diagram respectively first and second embodiments of an energy generating station according to the invention, when installed, preferably in an archipelago of islands, for example in the Maldives, to meet the needs for energy and resources in said archipelago. The invention, however, would not be limited just to this example of application.

According to FIGS. 3A and 3B, an energy generating station 1 according to the invention comprises an electric energy generating system 100. As specified previously, preferably such an electric energy generating system 100 uses OTE/OTEC technologies, consisting primarily of methods using a thermal gradient between cold deep seawater and tropical warm surface seawater to produce electricity without carbon emissions.

Thus, according to FIGS. 3A and 3B, the electric energy generating system 100 of a station 1 according to the invention comprises a first warm water WW supply circuit comprising a first pump 110 and a first warm water intake WWI cooperating with said first pump 110. Such first warm water WW supply circuit, represented by a plurality of solid dashes, makes fluid communication possible among all the elements contained in said first supply circuit and makes it possible to route the warm water WW to the electric energy generating system 100. Similarly, the electric energy generating system 100 of a station 1 according to the invention comprises a second cold water CW supply circuit comprising a second pump 190 and a second cold water intake CWI cooperating with said second pump 190. Such a second cold water supply circuit CW, represented by a plurality of dots, enables fluidic communication among all of the elements contained within said second supply circuit and makes it possible to route the cold water CW to the electric energy generating system 100. Advantageously but without limitation, such first and second supply circuits can comprise a plurality of pipes, advantageously flexible or rigid, suitable respectively for the transport of warm water WW and cold water CW, particularly under physical-chemical conditions, and more particularly pressure or flow rate conditions. Preferably, in order to deal with the constraints inherent in the installation and maintenance of the pipes underwater, particularly resistance to corrosion, and the different flow rates and pressures, said pipes can be composed primarily of high-density polyethylene (also known as HDPE). Moreover, the invention would not be limited to the type and/or nature of the elements constituting the first and second supply circuits: the pipes can be replaced by any means of equivalent capacity to ensure substantially identical function.

Thus, as mentioned previously, said first and second warm water WW and cold water CW supply circuits comprise a first warm water intake WWI and a second cold water intake CWI. Such first and second respective warm water intake WWI and cold water intake CWI make it possible to route the warm water and cold water to their respective supply circuit and can advantageously be produced in the form of one or more pipes (also known as “intake pipe”, advantageously and primarily composed of high-density polyethylene. Additionally, said first and second respective warm water intake WWI and cold water intake CWI can include or cooperate with one or more filters or strainers of HDPE or steel or any other suitable material, preventing the introduction of any outside element that could potentially damage or limit the performance of the pipes or pumps. Since the first warm water intake CWI is positioned in the surface waters, its being maintained can prove to be complex under some conditions due to the presence of currents and waves. To ensure the stability of said intake and to limit its movement, such first warm water intake CWI can also include or cooperate with one or more suitable ballasting and/or buoyancy means. The dimensions of the second cold water intake CWI are advantageously configured to be able to carry cold water from a sufficient depth, for example 700 or 1000 m deep, so that said cold water CW is at a temperature of about from 4° to 7° C.

Moreover, as previously mentioned, said first and second warm water WW and cold water CW supply circuits respectively comprise first and second pumps 110, 190 enabling the suction of warm water WW and cold water CW and their introduction into the respective supply circuits according to predetermined flow rates. Preferably, in order to satisfy the constraints inherent in the installation and maintenance of the pipes in seawater, particularly resistance to corrosion, and the different flow rates and pressures, said first and second pumps can be composed of a so-called “super duplex” type alloy material. The invention, however, is not limited to the number of pumps present in said supply circuits or to the nature of the materials of said pumps. Thus, in order to ensure sufficient flow rate, the invention provides that the first and second supply circuits can include a plurality of first and second pumps. Moreover, throughout the document, the invention is not limited only to the use of pumps: said pumps can be replaced by any means with equivalent capacity to ensure substantially identical function, i.e. any device or system enabling the circulation of fluid.

The electric energy generating system 100 of a station 1 according to the invention is configured to implement closed cycle OTE technology. To that end, to ensure operation of such an electric energy generating system 100, it comprises a working fluid WF supply circuit comprising a pump 130 for circulation of said working fluid WF. Such working fluid should advantageously have certain physical-chemical properties, particularly a relatively low boiling point or temperature, on the order of 19° C. under pressure. Advantageously but without limitation, such a working fluid WF can consist of ammonia. Nevertheless, in order to provide sufficient pressure to the system for generating electric energy, while employing non-hazardous refrigerant fluids, potentially with respect to the problems of global warming, such a working fluid WF is preferably and primarily composed of 1,1,1,2-tetrafluoroethane, since it is non-flammable and non-toxic. With respect to the circuit for supply of working fluid WF, advantageously closed, represented in FIGS. 3A and 3B by a plurality of closely spaced broken lines, enables fluidic communication of all the elements contained in said supply circuit and makes it possible to enable the circulation of the working fluid WF within the electric energy generating system 100. Like the first and second supply circuits, the working fluid WF supply circuit comprises a plurality of pipes, advantageously flexible or rigid, suitable respectively for the transport of working fluid WF, particularly under physical-chemical conditions and more particularly pressure or flow rate conditions. Preferably, in order to satisfy the constraints inherent in the installation and maintenance of pipes in seawater, particularly resistance to corrosion, and the different flow rates and pressures, said pipes can be composed primarily of high-density polyethylene (HDPE). Moreover, the invention is not limited to the type and/or nature of the elements constituting the working fluid WF supply circuit: the pipes can be replaced by any means with equivalent capacity to ensure substantially identical function.

Furthermore, in order to implement the closed cycle of the electric energy generating system 100, said system also comprises a first thermal exchanger 120 cooperating fluidly, i.e. being in fluidic communication, with said first warm water WW supply circuit and said working fluid WF supply circuit. The warm water WW, advantageously drawn at the surface at a temperature on the order of 25 to 35° C., is routed to the first thermal exchanger 120 by means of the first supply circuit. The warm water WW then circulates through the first thermal exchanger 120 and transfers its heat in the form of calories in order to bring the working fluid WF to the boiling point, which changes to the vapor state. Thus, the first thermal exchanger 120, also called first heat exchanger or evaporator, advantageously allows the transfer of the thermal energy in the form of heat from the warm water WW to the working fluid WF through an exchange surface ensuring the separation of the warm water WW and the working fluid WF. It is this transfer of thermal energy or heat that enables the vaporization of said working fluid WF. By way of preferred but non-limiting example, the first thermal exchanger 120 can advantageously consist of a plate exchanger, also known as plate thermal exchanger or gasket type thermal exchanger. Said first thermal exchanger, advantageously of plates or any other exchanger technology guaranteeing the efficiency of the system, can comprise plates preferably composed of titanium, to ensure longevity of said thermal exchanger.

The working fluid WF, in vapor form, then expands through one or possibly a plurality of turbines driving one or a plurality of generators in order finally to create electric energy. Also, the electric energy generating system 100 of a station 1 according to the invention comprises a turbine 140 cooperating fluidly, i.e. being in fluidic communication, thanks to the working fluid WF, with the first thermal exchanger 120. Preferably but without limitation, such a turbine 140 consists of a single axial impulse type turbine, possibly with partial admission (not shown in FIGS. 3A and 3B) of working fluid WF vapor, said partial admission making it possible to control the output power of the turbine. The kinetic energy of the working fluid WF in vapor form allows the blades, on which the action of the working fluid WF is exerted, to be driven in rotation, and a shaft S, said blades being in said turbine 140. Thermal energy is thus converted into mechanical energy.

All or part of said mechanical energy can then be converted into electric energy. To do this, the electric energy generating system 100 of a station 1 according to the invention comprises an electricity generator 150 cooperating with said turbine 140 by a mechanical linkage. Thus, the turbine 140 and the electricity generator 150 of the electric energy generating system can be connected to form a single entity, said entity being commonly called a turbogenerator or turboalternator. The mechanical linkage between the turbine 140 and the generator 150, possibly in the form of a clamp, pivot or ball connection, is advantageously achieved by the shaft S actuated by the blades of the turbine, said shaft S enabling the transmission of the mechanical energy so that it is converted to electric energy by the generator. By way of preferred example, the generator 150 of the electricity generating system 100 can advantageously comprise an electric generator with permanent magnets mounted rotatably on the shaft S relative to windings of the electric conductor.

Next, the electric energy generating system 100 operating in closed cycle, the vapor of the working fluid WF is again condensed into liquid in order finally to be recycled within said electric energy generating system. To do this, said electric energy generating system 100 also comprises a second thermal exchanger 180 cooperating fluidly, i.e. being in fluidic communication, with said second cold water CW supply circuit and said working fluid WF supply circuit. The cold water CW, advantageously drawn from depths on the order of 700 m to 1000 m at a temperature on the order of 4° C. to 7° C., is routed to the second thermal exchanger 180 by means of the second supply circuit. The cold water CW then circulates through the second thermal exchanger 180 and transfers its thermal energy in order to condense the working fluid WF, which changes from gaseous to liquid state. Thus, the second thermal exchanger 180, also called second heat exchanger or condenser, advantageously allows the transfer of thermal energy from the cold water CW to the working fluid WF through an exchange surface ensuring the separation of the cold water CW and the working fluid WF. It is this transfer of thermal energy that enables the condensation of said working fluid WF. Advantageously but without limitation, like the first thermal exchanger 120, a second thermal exchanger 180 can consist of a double wall exchanger. By way of preferred but non-limiting example, the second thermal exchanger 180 can consist of a plate thermal exchanger or gasket type thermal exchanger.

Once the working fluid WF is again in liquid state, an electric energy generating cycle through the generating system 100 is again implemented, the warm water WW and cold water CW are then routed outside the system, since their respective temperatures are no longer suitable for supplying the first and second thermal exchangers 120, 180, in order respectively to vaporize and condense the working fluid WF. To that end, the electric energy generating system 100 of an energy generating station 1 according to the invention comprises a water outlet WO cooperating fluidly, i.e. in fluidic communication, with the first and second thermal exchangers 120 and 180. Such a water outlet WO can advantageously comprise or cooperate with water collection means (not shown in the figures), suitable for collecting the water W. Such collection means can possibly consist of one or more nozzles, channels, pipes or drains. Said water outlet WO can possibly and directly communicate with the seawater in order to discharge, even if only a portion, of the waste warm and cold water from the operation of the electric energy generating system 100. As a variant or as complement, the water outlet WO can include or cooperate with a storage reservoir (not shown in the figures), adapted and/or configured to preserve or transfer the water W for future use during a specific time period.

As specified previously, one of the numerous advantages of a generating station 1 according to the invention is to propose an integrated all-in-one system, suitable in particular to be used on isolated sites. Also, the energy produced, such as for example those represented in relation to FIG. 2, can consist, non-exhaustively, of electricity, air conditioning, freshwater, potable water, warm water, water suitable for use in agriculture or aquaculture. Also, the “waste” waters at the water outlet WO of the electric energy generating system 100 can potentially be reused for the implementation of another system and the production of other energy, such as those defined in the sense of the invention and in relation to FIG. 2. According to FIGS. 3A and 3B, an energy generating station 1 according to the invention further comprises a warm water and cold water generating system 200 cooperating fluidly, i.e. in fluidic communication, with the water outlet WO of said electric energy generating system 100. The “waste” waters at the water outlet WO of the electric energy generating system 100 are reused for the implementation of another system and the production of other energy, such as those defined in the sense of the invention and in relation to FIG. 2, particularly the generation of warm and cold water. The fluid communication between the water outlet WO of the electric energy generating system 100 and the warm water and cold water generating system can advantageously be achieved by one or more pipes, advantageously flexible or rigid, suitable respectively for the transport of the water W, particularly under the physical-chemical conditions of said water, and more particularly the pressure and/or flow rate. Potentially, in order to increase the production of freshwater, the water outlet WO could cooperate with a heating device. Preferably, in order to respond to the constraints inherent in the installation and maintenance of pipes under water, particularly resistance to corrosion, the different flow rates and pressures, said pipes can be comprised principally of high-density polyethylene.

In order finally to obtain the energy expected, according to FIGS. 3A and 3B, the warm water and cold water generating system 200 of an energy generating station according to the invention is based on the principal and technologies of heat pumps. Since the system 200 makes it possible to generate both warm water and cold water, it can be called a “heat-cooling-pump.” Also, according to FIGS. 3A and 3B, such a warm water and cold water generating system 200 includes third and fourth water W supply circuits respectively comprising third and fourth pumps 210, 290, said pumps cooperating fluidly upstream with the water outlet WO of said electric energy generating system 100. Like the first and second supply circuits respectively of warm water WW and cold water CW, said third and fourth water W supply circuits, represented by a plurality of broken solid lines, make it possible to place all of the elements in fluidic communication that are contained in said third and fourth supply circuits and to route the water W to the warm water and cold water generating system 200. Advantageously but without limitation, such third and fourth water W supply circuits can include a plurality of pipes, advantageously flexible or rigid, suitable respectively for the transport of the water W, particularly under the physical-chemical conditions, and more particularly for pressure or flow rate. Preferably, in order to respond to the constraints inherent in the installation and maintenance of the pipes in seawater, particularly resistance to corrosion and the different flow rates and pressures, said pipes can be composed primarily of high-density polyethylene (HDPE). Moreover, the invention would not be limited to the type and/or nature of the elements constituting the first and second supply circuits: the pipes can be replaced by any means of equivalent capacity to ensure a substantially identical function. As previously mentioned, the third and fourth pumps 210, 290 allow the suction of the water W at the water outlet WO of the electric generating system 100 and the introduction thereof respectively into the third and fourth supply circuits according to predetermined flow rates.

Generally, current heat pumps operate in closed-circuit and require the use of a fluid called refrigerant to ensure the heat transfers. Thus, the warm water and cold water generating system of an energy generating station according to the invention also comprises a refrigerant fluid RF supply circuit comprising a pressure reducer 230 of said refrigerant fluid RF. Such a refrigerant fluid RF must advantageously have certain physical-chemical properties: indeed, to meet the dual problem of warm water and cold water generation, such refrigerant fluid must be capable of absorbing a large quantity of heat in the form of calories in order to generate the cold water, but also to restore the same quantity of heat in order to generate the warm water. Moreover, said refrigerant fluid RF must further respect safety standards and prevent any risk related to the environment or hazard for humans. By way of non-limiting examples, such a refrigerant fluid RF can be 1,1,1,2-tetrafluoroethane. The refrigerant fluid RF supply circuit, which is advantageously closed, represented by a plurality of dashes and dots, enables fluidic communication of all of the elements contained in the supply circuit and the circulation of the refrigerant fluid RF within the warm water and cold water generating system 200. Like other supply circuits already presented in the energy generating station, the refrigerant fluid RF supply circuit can comprise a plurality of pipes, advantageously flexible or rigid, suitable respectively for the transport of refrigerant fluid, particularly for the physical-chemical conditions, and more particularly for pressure or flow rate. Preferably, in order to respond to the constraints inherent in the installation and maintenance of the pipes in seawater, particularly resistance to corrosion, and the different flow rates and pressures, said pipes can be composed primarily of high-density polyethylene. Moreover, the invention would not be limited to the type and/or nature of the elements constituting the refrigerant fluid RF supply circuit: the pipes can be replaced by any means of equivalent capacity to ensure a substantially identical function.

Furthermore, when the heat pumps are operating in closed-circuit, they generally have principal components cooperating fluidly by means of the refrigerant fluid RF, including in particular:
a condenser, enabling the change of the water W to warm water WW by the release of heat from the refrigerant fluid RF;
a pressure reducer, also called expansion valve, reducing the pressure of the refrigerant fluid RF in liquid phase;
an evaporator, enabling the “removal” of heat in the form of calories from the water W in order to vaporize the refrigerant fluid RF;
a compressor, actuated by any suitable means, generally electric and raising the pressure and temperature of the refrigerant fluid in the form of vapor by compressing it.

Also, in order to implement a closed cycle of a heat pump as previously described, the warm water and cold water generating system 200 of an energy generating station according to the invention comprises first of all a third thermal exchanger 220 cooperating fluidly, i.e. being in fluidic communication, with said third water W supply circuit and said refrigerant fluid RF supply circuit. The water W removed at the outlet WO, as a variant possibly at the warm water intake WWI and/or cold water intake CWI, of the electric energy generating system is routed to the third thermal exchanger 220 by means of the third water W supply circuit. The water W then circulates within the third thermal exchanger 220 and recovers the heat in the form of calories restored by the refrigerant fluid RF, the latter being in gaseous state and compressed: the warm water WW is then produced. The third thermal exchanger, also called third heat exchanger or condenser, advantageously enables the transfer of the thermal energy in the form of heat from the refrigerant fluid RF to the water W through an exchange surface ensuring the separation of the water W and the refrigerant fluid RF. Such a transfer results in the change of the refrigerant fluid RF from the gaseous state to the liquid state, since said refrigerant fluid has transmitted its energy to the water W. By way of non-limiting example, such a third thermal exchanger 220 can consist of a U-tube thermal exchanger, a vertical or horizontal tube-bundle exchanger, a plate exchanger, a fin exchanger or a coil exchanger.

Once produced, the warm water WW can be collected and finally used to meet the warm water needs on the installation site of the energy generating station. To do this, the warm water and cold water generating system 200 of an energy generating station 1 according to the invention comprises a warm water outlet FWWO cooperating fluidly, i.e. in fluidic communication, with the third thermal exchanger 220. Such a warm water outlet FWWO can advantageously comprise or cooperate with water collection means (not shown in the figures), suitable for collecting the warm water WW. Such collection means can potentially consist of one or more nozzles, channels, pipes or drains. Said warm water outlet FWWO can potentially and directly communicate with the infrastructures or installations in which the warm water WW will be directly used. As a variant or complement, the warm water outlet FWWO can include or cooperate with a storage reservoir (not shown in the figures), adapted and/or configured to preserve the warm water WW for future use during a specific time period. At the outlet of the condenser or third thermal exchanger 220, the refrigerant fluid RF is advantageously in liquid form and the temperature thereof decreases greatly. The refrigerant fluid RF is then routed to the pressure reducer means 230 of the refrigerant fluid RF supply circuit. The pressure reducer 230, also known as expansion valve, allows the pressure of the refrigerant fluid RF to be reduced in order to facilitate the evaporation thereof.

Subsequently, in order to enable the evaporation of the refrigerant fluid RF, a warm water and cold water generating system also comprises a fourth thermal exchanger 280 cooperating fluidly, i.e. in fluidic communication, with said fourth water W supply circuit and said refrigerant fluid RF supply circuit. The water W removed at the outlet WO of the electric energy generating system 100 is routed towards the fourth thermal exchanger 280 by means of the fourth water W supply circuit. The water W circulates then within the fourth thermal exchanger and restores the heat in the form of calories, the said heat being recovered by the refrigerant fluid RF, the latter being in liquid state: the cold water CW is then produced. Thus, the fourth thermal exchanger, also called fourth heat exchanger or evaporator, advantageously allows the transfer of the thermal energy in the form of heat from the water W to the refrigerant fluid RF through an exchange surface ensuring the separation of the water W and the refrigerant fluid RF. Such a transfer results in the change of the refrigerant fluid RF from the liquid state to the gaseous state, since said refrigerant fluid RF recovers the energy by evaporating. By way of non-limiting example, such a fourth thermal exchanger 280 can consist of a U-tube exchanger, a horizontal or vertical tube-bundle exchanger, a plate exchanger, a fin exchanger or a coil exchanger.

Once produced, the cold water CW can be collected and finally used to meet the needs for cold water on the installation site of the energy generating station. To do this, the warm water and cold water generation system 200 of an energy generating station 1 according to the invention comprises a cold water outlet FCWO cooperating fluidly (i.e. in fluidic communication, with the fourth thermal exchanger 280. Such a cold water outlet FCWO can advantageously comprise or cooperate with water collection means (not shown in the figures), suitable for collecting the cold water CW. Such collection means can potentially consist of one or more nozzles, channels, tubes or drains. Said cold water outlet FCWO can potentially and directly communicate with the infrastructures or installations in which the cold water CW will be directly used. As a variant or in addition, the cold water outlet FCWO can comprise or cooperate with a storage reservoir (not shown in the figures), suitable and/or configured for preserving the cold water CW for future use during a specific period.

Once vaporized, the refrigerant fluid RF must be compressed in order to be able to perform a heat transfer. The warm water and cold water generating system 200 of an energy generating station 1 according to the invention comprises a compressor 240 cooperating fluidly, i.e. in fluidic communication, with the third thermal exchanger 220 and the fourth thermal exchanger 280. The refrigerant fluid RF is compressed in the compressor 240 and therefore changes from a low pressure to a higher pressure thanks to the mechanical energy provided by the compressor 240. At a minimum, said compressor 240 comprises a mechanical shaft S (not shown in FIG. 3A) and means for compressing the refrigerant fluid RF cooperating mechanically with said mechanical shaft S. By way of advantageous but non-limiting examples, the compressor 240 of a warm water and cold water generating system 200 can be selected from:
a reciprocating compressor, comprising one or more pistons, a cylinder for compressing the refrigerant fluid RF in which the piston(s) slide sealably, the refrigerant fluid RF being admitted into the cylinder by means of a valve as a result of the suction caused by the retraction of the piston(s);
a screw compressor, comprising a cylinder into which the refrigerant fluid RF is admitted, a rotary part enclosed by the cylinder and a rotating endless screw to compress the gaseous refrigerant fluid RF between the cylinder and the rotary part driven by said screw;
a so-called “scroll” compressor, comprising a rotor in coil form, said rotor compressing the gaseous refrigerant fluid RF continuously by rotating around another fixed coil.

At the outlet of the compressor 240, the refrigerant fluid RF is in gaseous form at high pressure and high temperature. A warm water and cold water generating cycle can again be carried out.

The constraints related to the site where an energy generating station according to the invention is established require the development of new arrangements or configurations to facilitate the installation and maintenance of said station. Thus, the invention provides a clever configuration enabling the combination of energy potentially produced by the electric energy generating system 100 and which are necessary for the implementation of the warm water and cold water generating system 200. Thus, the compressor 240 of the warm water and cold water generating system 200 of an energy generating station 1 according to the invention is powered by the generator 150 of the electric energy generating system 100 thereof. First and second embodiments of such powering will be described respectively in relation to FIGS. 3A and 3B in the following.

Advantageously, according to a first embodiment of an energy generating station 1 according to the invention, described with reference to FIG. 3A, the compressor 240 of a warm water and cold water generating system can be powered by the electric energy delivered by the generator 150 of the electric energy generating system 100. Such an arrangement proves to be particularly clever, since it makes it possible to pool the usable resources to make one system of the energy generating station 1 operate using energy produced by another system. In this instance the electric energy produced by the electric energy generating system 100 makes it possible to implement the warm water and cold water generating system 200 and to reduce, or even eliminate in some cases, the external means necessary for the full implementation of said energy generating station and in the end to propose a practically self-sufficient station.

As a variant or in addition, according to a second embodiment of an energy generating station 1 according to the invention, described with reference to FIG. 3B, the turbine 140 and the electricity generator 150 of the electric energy generating system 100 can cooperate mechanically by means of a mechanical shaft S, by a mechanical linkage involving, advantageously but without limitation, clamping, pivot or ball linkage, or even a single shaft: it then forms a turbogenerator. Moreover, said shaft S of the turbogenerator can also cooperate mechanically with, i.e. be integral with using a suitable mechanical linkage, the compressor 240 in order to drive the latter. Thus, irrespective of the structural arrangement of the compressor 240, the shaft S of the turbine 140, more specifically the shaft S of the turbogenerator, can directly drive or power the compressor 240, more particularly the means for compressing the refrigerant fluid RF of the compressor 240. Such a configuration proves particularly advantageous since it makes it possible not only to pool the usable resources to operate one system of the energy generating station 1 with the energy produced by another system, but also to reduce consumption of electric energy and ultimately the maintenance costs of said station 1. Indeed, in contrast to the first embodiment of an energy generating station 1 according to the invention, described with reference to FIG. 3A, using the electric energy produced by the generator 150 to power the compressor 240, the driving of the compressor 240 according to the second embodiment of an energy generating station 1 according to the invention is achieved by mechanical energy.

As already mentioned, an energy generating station 1 according to the invention consists primarily of an integrated all-in-one system and is suitable in particular for being implemented on an isolated site, making available to users on said isolated site a number of different and modular sources of energy. Also, in addition or as a variant, such isolated site can have needs for freshwater, potable water or water appropriate for consumption in cooking or in agriculture. Thus, according to FIGS. 3A and 3B, such an energy generating station can comprise a desalination module 300 cooperating fluidly, i.e. in fluidic communication with, upstream from said desalination module 300, the water outlet WO of the electric energy generating system 100, thus making it possible to recycle the “waste” waters produced by said electric energy generating system 100. Potentially, as a variant or in addition (embodiment not shown in the figures), said desalination module 300 can be supplied directly, in all or in part, with seawater by means of a seawater intake and suitable distribution means, in the form of a distributor or a regulating valve cooperating with one or more pipes.

A desalination module 300 of an energy generating station 1 according to the invention then comprises a pump 320, enabling the water under pressure to be routed and a reverse osmosis membrane 330 supplied with water by said pump 320, a freshwater outlet FWO cooperating fluidly, i.e. in fluidic communication, with said reverse osmosis membrane 330. The reverse osmosis membrane 330 can advantageously be selected from tubular shaped membranes, flat membranes (also known as pillow shaped) or spiral-wound membranes. It is the spiral-wound membranes that are generally preferred, since they prove to be the most suitable due to low replacement costs and easy maintenance. However, the invention is not limited to the nature or number of reverse osmosis membranes present within the desalination module 300. Moreover, such a desalination module 300 can also comprise one or more filters positioned upstream from the membrane 330 (not shown in FIGS. 1, 3A and 3B) configured to separate in advance the water W from any sediment, sand or detritus and thus preserve the integrity of the reverse osmosis membrane 330. Other filters can also be present within said desalination module 300 downstream from the membrane 330 (not represented in FIGS. 1, 3A and 3B) making it possible to extract any gustatory or odorous elements making the water unsuitable for consumption. Furthermore, as a variant or in addition, like the warm water and cold water generating system, if necessary the desalination module of an energy generating station 1 according to the invention can be supplied with electric energy by the electric energy generating system 100 of said station.

The freshwater outlet FWO can advantageously comprise or cooperate with water collection means (not shown in the figures), suitable for collecting the water W. Such collection means can potentially consist of one or more nozzles, channels, pipes or drains. Said cold water outlet FWO can potentially and directly communicate with the infrastructures or installations in which the freshwater W will be directly used. As a variant or in addition, the freshwater outlet FWO can comprise or cooperate with a storage reservoir (not shown in the figures), adapted and/or configured to preserve the freshwater W for future use during a specific period. However, according to the invention, the freshwater W produced can be used to operate the warm water and cold water generating system of an energy generating station according to the invention, thus enabling the pooling of resources used and energy produced. Also, according to preferred embodiments, such as those described with reference to FIGS. 3A and 3B, the desalination module 300 of an energy generating station 1 according to the invention can cooperate fluidly, i.e. in fluidic communication, downstream from said desalination module 300, with the third and fourth water supply circuits of the warm water and cold water generating system 200. The warm water outlet FWWO and cold water outlet FCWO, as well as the third warm water WW supply circuit and the fourth cold water CW supply circuit, will consist, according to these advantageous embodiments, of fresh warm water outlet FWWO and fresh cold water outlet FCWO, as well as the third warm water at WW supply circuit and fourth cold water CW supply circuit.

The installation sites where an energy generating station 1 according to the invention is generally planned, in most cases are located in hot tropical regions. In such regions, air conditioning is greatly appreciated. Also, as a variant or in addition, according to FIGS. 1, 3A and 3B, an energy generating station 1 according to the invention can also include an air conditioning energy generating system 400, cooperating fluidly, i.e. in fluidic communication, with the water outlet WO or potentially the cold water inlet CW of the electric energy generating system 100 of the same station, thus enabling the recycling of “waste” waters produced by said electric energy generating system 100 or working by sharing the means with said electric energy generating system 100. Potentially, as a variant or in addition (embodiment not shown in the figures), like the desalination module 300, said air conditioning energy generating system 400 can also be supplied directly, in all or in part, by seawater, by means of a seawater intake and suitable distribution means advantageously in the form of a distributor or regulating valve cooperating with one or more pipes.

An air conditioning energy generating system 400 of an energy generating station 1 is based on the cold seawater cooling principal and technologies (better known as Sea Water Air Cooling, SWAC). According to first and second embodiments described with reference to FIGS. 3A and 3B, said air conditioning energy generating system 400 can first comprise a fifth water W supply circuit comprising a fifth pump 410 and cooperating fluidly with the water outlet WO or potentially the cold water intake CWI. Such fifth water W supply circuit enables all elements contained in said fifth supply circuit to be placed in fluidic communication and to circulate the water W within the air conditioning energy generating system 400. Like other supply circuits already presented in the energy generating station, the fifth water W supply circuit can comprise a plurality of pipes, advantageously flexible or rigid, suitable respectively for transporting the water W, particularly under physical-chemical conditions, and more particularly pressure and flow rate. Preferably, in order to meet the constraints inherent in the installation and maintenance of the pipes in seawater, particularly resistance to corrosion and the different pressures and flow rates, said pipes can be composed primarily of high-density polyethylene. Moreover, the invention is not limited to the type and/or nature of the members constituting the fifth water W supply circuit: the pipes can be replaced by any means of equivalent capacity to ensure substantially identical function.

Generally, current heat pumps operate in closed-circuit and require the use of a heat transfer fluid to ensure the thermal transfers. Thus, the air conditioning energy generating system 400 of an energy generating station 1 according to the invention can also include a heat transfer fluid HTF supply circuit comprising a circulation pump 440 of said heat transfer fluid HTF. Such heat transfer fluid HTF advantageously has certain physical-chemical properties: indeed, such heat transfer fluid should be able to absorb a large quantity of heat in the form of calories in order to generate conditioned air. Moreover, said heat transfer fluid HTF should comply with safety standards and prevent any risk related to and involving the environment or to hazards to humans. By way of non-limiting examples, such a heat transfer fluid HTF can be glycol water. The heat transfer fluid HTF supply circuit, advantageously closed, represented in FIGS. 3A and 3B by a line formed by dashes each followed by two dots, enables all the members contained in said supply circuit to be placed in fluidic communication and to circulate the heat transfer fluid HTF within the air conditioning energy generating system 400. Like other supply circuits already presented in the energy generating station, the heat transfer fluid HTF supply circuit can include a plurality of pipes, advantageously flexible or rigid, suitable respectively for the transport of heat transfer fluid HTF, particularly under physical-chemical conditions, and more particularly pressure or flow rate. Preferably, in order to respond to the constraints inherent in the installation and in the maintenance of the pipes in seawater, particularly with reference to resistance to corrosion and the different flow rates and pressures, said pipes can be composed principally of high-density polyethylene.

In order to implement a thermodynamic cycle of an air conditioning energy generating system 400, said system also comprises a fifth thermal exchanger 420 cooperating fluidly with said fifth water W supply circuit and said heat transfer fluid HTF supply circuit. The water W drawn at the outlet WO or potentially at the cold water intake CW of the electric energy generating system 100 is routed to the fifth thermal exchanger 420 by means of the fifth water W supply circuit. The water W then circulates within the fifth thermal exchanger 420 and recovers the heat in the form of calories restored by the heat transfer fluid HTF, the latter remaining in liquid state; warm water WW is therefore produced. Once produced, the warm water WW can be collected and finally used to meet the needs for warm water present on the installation site of the energy generating station. Thus, the fifth thermal exchanger 420, also called fifth heat exchanger, advantageously makes it possible to transfer the thermal energy in the form of heat from the heat transfer fluid HTF to the water W through an exchange surface ensuring the separation of the water W and the heat transfer fluid HTF. By way of non-limiting example, such fifth thermal exchanger 420 can consist of a U-tube exchanger, a horizontal or vertical tube-bundle exchanger, a plate exchanger, a thin exchanger, or a coil exchanger.

The heat transfer fluid HTF is then routed by means of the circulation pump 440 of the heat transfer fluid HTF supply circuit. Finally, the air conditioning energy generating system 400 comprises a sixth thermal exchanger 430, enabling the supply of conditioned air. Such sixth thermal exchanger 430 cooperates fluidly, i.e. it is in fluidic communication, with said heat transfer fluid HTF supply circuit. Air is taken from the vicinity of the sixth thermal exchanger 430 and introduced into said sixth thermal exchanger 430. The heat transfer fluid HTF then circulates within the sixth thermal exchanger and recovers the heat from the air in the form of calories. The cold conditioned air is thus produced and expelled. Such conditioned air can then be routed by means of suitable ducts, then delivered and used to temper certain enclosures or infrastructures of the installation site having need of conditioned air. Thus, the sixth thermal exchanger 430 advantageously makes it possible to transfer the thermal energy in the form of heat from the air to the heat transfer fluid HTF through an exchange surface ensuring the separation of the air and the heat transfer fluid HTF. By way of non-limiting example, such sixth thermal exchanger 430 can be selected from a U-tube exchanger, a horizontal or vertical tube-bundle exchanger, a plate exchanger, a fin exchanger, or a coil exchanger.

Moreover, as a variant or in addition, the electric energy produced and delivered by the electric energy generating system 100 of an energy generating station 1 according to the invention can advantageously be used for the implementation of said air conditioning energy generating system 400.

The invention has been described for use and/or application in relation to a hotel complex situated in an archipelago of isolated islands. It can also be implemented for any other categories of sites, such as for example isolated communities, government and/or military installations, large industrial and/or commercial complexes, universities, airports or data centers having the capacity to implement OTEC type technologies, i.e. in any part of the world where the necessary difference in temperatures, i.e. on the order of 20° C., between a warm source and a cold source can be observed throughout the year, typically in tropical waters.

Other modifications can be considered without going beyond the scope of the present invention defined by the claims appended hereto.

1. An energy generating station, comprising:
an electric energy generating system comprising:
a first warm water supply circuit comprising a first pump and a first warm water intake cooperating with said first pump;
a second cold water supply circuit comprising a second pump and a second cold water intake cooperating with said second pump;
a working fluid supply circuit comprising a circulation pump for circulating working fluid;
a first thermal exchanger cooperating fluidly with said first warm water supply circuit and said working fluid supply circuit;
a second thermal exchanger cooperating fluidly with said second cold water supply circuit and said working fluid supply circuit;
a turbine cooperating fluidly with the first and second thermal exchangers;
an electricity generator cooperating with said turbine by mechanical linkage; and
a water outlet cooperating fluidly with the first and second thermal exchangers, said station further including a warm water and cold water generating system cooperating fluidly with the water outlet of said electric energy generating system and comprising:
a third water supply circuit comprising a third pump cooperating fluidly upstream with the water outlet of said electric energy generating system;
a fourth water supply circuit comprising a fourth pump cooperating fluidly upstream with the water outlet of said electric energy generating system;
a refrigerating fluid supply circuit cooperating with a pressure reducer of said refrigerating fluid;
a third thermal exchanger cooperating fluidly with said third water supply circuit and said refrigerating fluid supply circuit;
a fourth thermal exchanger cooperating fluidly with said fourth water supply circuit and said refrigerating fluid supply circuit;
a compressor cooperating fluidly with the third and fourth thermal exchangers;
a fresh warm water outlet cooperating fluidly with said third thermal exchanger;
a fresh cold water outlet cooperating fluidly with said fourth thermal exchanger;
wherein the compressor of the warm water and cold water generating system is powered by the generator of the electric energy generating system.

2. The energy generating station as claimed in claim 1, wherein said compressor is powered by the electric energy delivered by said generator.

3. The energy generating station as claimed in claim 1, wherein the turbine and the electricity generator of the electric energy generating system cooperate mechanically by means of a mechanical shaft, said shaft also cooperating mechanically with the compressor to drive said compressor.

4. The energy generating station as claimed in claim 1, further comprising a desalination module, comprising a pump and a reverse osmosis membrane supplied with water by said pump, a freshwater outlet cooperating fluidly with said reverse osmosis membrane, said desalination module cooperating fluidly, upstream from said desalination module, with the water outlet of the electric energy generating system, and downstream from said desalination module, with the third and fourth water supply circuits of the warm water and cold water generating system.

5. The energy generating station as claimed in claim 1, also comprising an air conditioning energy generating system cooperating fluidly with the water outlet of the electric energy generating system, the air conditioning energy generating system comprising:
a fifth water supply circuit comprising a fifth pump and cooperating fluidly with the water outlet;
a heat transfer fluid supply circuit comprising a circulation pump f said heat transfer fluid;
a fifth thermal exchanger cooperating fluidly with said fifth water supply circuit and said heat transfer fluid supply circuit;
a sixth thermal exchanger cooperating fluidly with said heat transfer fluid supply circuit.
